(19) United States
(12) Patent Application Publication
(10) Pub. No.: US 2012/0078595 A1
(43) Pub. Date: Mar. 29, 2012

(54) METHOD AND APPARATUS FOR ONTOLOGY MATCHING

(75) Inventors: Sergey Balandin, Helsinki (FI); Sergey Boldyrev, Soderkulla (FI); Ian Justin Oliver, Soderkulla (FI); Timofey Turenko, Espoo (FI); Alexander Victorovich Smirnov, Saint-Petersburg (RU); Nikolay Germanovich Shilov, Saint-Petersburg (RU); Alexey Mixailovich Kashevnik, Saint-Petersburg (RU)

(73) Assignee: Nokia Corporation, Espoo (FI)

(21) Appl. No.: 12/890,142

(22) Filed: Sep. 24, 2010

(51) Int. Cl. G06G 7/48

(52) U.S. Cl. 703/6

(57) ABSTRACT

An approach is provided for ontology matching. An information space infrastructure determines a first ontology and a second ontology. The first ontology and the second ontology describe one or more information closures, one or more computation closures, or a combination thereof. The information space infrastructure then determines to apply a plurality of comparison models on the first ontology and the second ontology and to compute a degree of similarity of the first ontology and the second ontology based, at least in part, on the plurality of comparison models.

### BACKGROUND

Increasingly, more and more applications and services are being developed around the interactivity and interoperability of wireless communication devices, particularly in the area of information storage, searching and retrieval among a select group of interconnected devices. One means of facilitating such interaction is through the configuration of individual and personal information spaces, where individuals or groups can place, share, interact and manipulate webs of information with their own locally agreed upon semantics. Interaction between devices within an information space readily enables application of group defined semantics and organization of information at a local, rather than global level. Moreover, applications may be deployed to support distributed information sharing and computing among the various devices having access to the information space. Applications operable within the information space may therefore operate upon any gathered information for enabling computations to be executed.

Typically, interaction between devices within an information space for executing applications and/or supporting data exchange is facilitated by one or more knowledge processors (KPs). KPs are executable components that are deployed within the information space to supply and retrieve information based on the established semantic framework. By way of example, the KPs may be implemented upon or accessed by a device to support applications for performing research, document retrieval, querying, information processing, content presentment and the like. However, with the myriad of different people, groups and devices having access to an information space at anytime, there is a greater need to enable interoperability of KPs. Lack of semantic alignment between KPs of different user devices having access to the shared information space prevents application and user requests from being properly executed, thereby diminishing the quality of the user experience for all users.

### SOME EXAMPLE EMBODIMENTS

Therefore, there is a need for an approach to enabling interoperability among devices having access to a shared information space.

According to one embodiment, a method comprises determining a first ontology and a second ontology, wherein the first ontology and the second ontology describe one or more information closures, one or more computation closures, or a combination thereof. The method also comprises determining to apply a plurality of comparison models on the first ontology and the second ontology. The method further comprises determining to compute a degree of similarity of the first ontology and the second ontology based, at least in part, on the plurality of comparison models.

According to another embodiment, an apparatus comprises at least one processor, and at least one memory including computer program code, the at least one memory and the computer program code configured to, with the at least one processor, cause, at least in part, the apparatus to determine a first ontology and a second ontology, wherein the first ontology and the second ontology describe one or more information closures, one or more computation closures, or a combination thereof. The apparatus is also caused to determine to apply a plurality of comparison models on the first ontology and the second ontology. The apparatus is further caused to determine to compute a degree of similarity of the first ontology and the second ontology based, at least in part, on the plurality of comparison models.

According to another embodiment, a computer-readable storage medium carries one or more sequences of one or more instructions which, when executed by one or more processors, cause, at least in part, an apparatus to determine a first ontology and a second ontology, wherein the first ontology and the second ontology describe one or more information closures, one or more computation closures, or a combination thereof. The apparatus is also caused to determine to apply a plurality of comparison models on the first ontology and the second ontology. The apparatus is further caused to determine to compute a degree of similarity of the first ontology and the second ontology based, at least in part, on the plurality of comparison models.

According to another embodiment, an apparatus comprises means for determining a first ontology and a second ontology, wherein the first ontology and the second ontology describe one or more information closures, one or more computation closures, or a combination thereof. The apparatus also comprises means for determining to apply a plurality of comparison models on the first ontology and the second ontology. The apparatus further comprises means for determining to compute a degree of similarity of the first ontology and the second ontology based, at least in part, on the plurality of comparison models.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of enabling interoperability among devices having access to a shared information space, according to one embodiment;

FIG. 2 is a diagram of the components of an information space support infrastructure enabling, according to one embodiment;

FIG. 3 is a diagram of a matching model for processing ontology within an information space, according to one embodiment;

FIGS. 4A and 4B are flowcharts depicting processes for enabling interoperability among devices having access to a shared information space, according to various embodiments;

FIGS. 5, 6, 7A and 7B are diagrams depicting an interaction between a semantic information broker and one or more knowledge processors for executing the processes of FIGS. 4A and 4B, according to various embodiments;

FIG. 8 is a diagram of hardware that can be used to implement an embodiment of the invention;

FIG. 9 is a diagram of a chip set that can be used to implement an embodiment of the invention; and

FIG. 10 is a diagram of a mobile terminal (e.g., handset) that can be used to implement an embodiment of the invention.

### DESCRIPTION OF SOME EMBODIMENTS

Examples of a method, apparatus, and computer program for enabling interoperability among devices having access to a shared information space are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

Although various embodiments are described with respect to information spaces and various accompanying information protocols, it is contemplated that the approach described herein may be used with other platforms, structures and computing environments to create models of information for enabling the sharing and computing of such information.

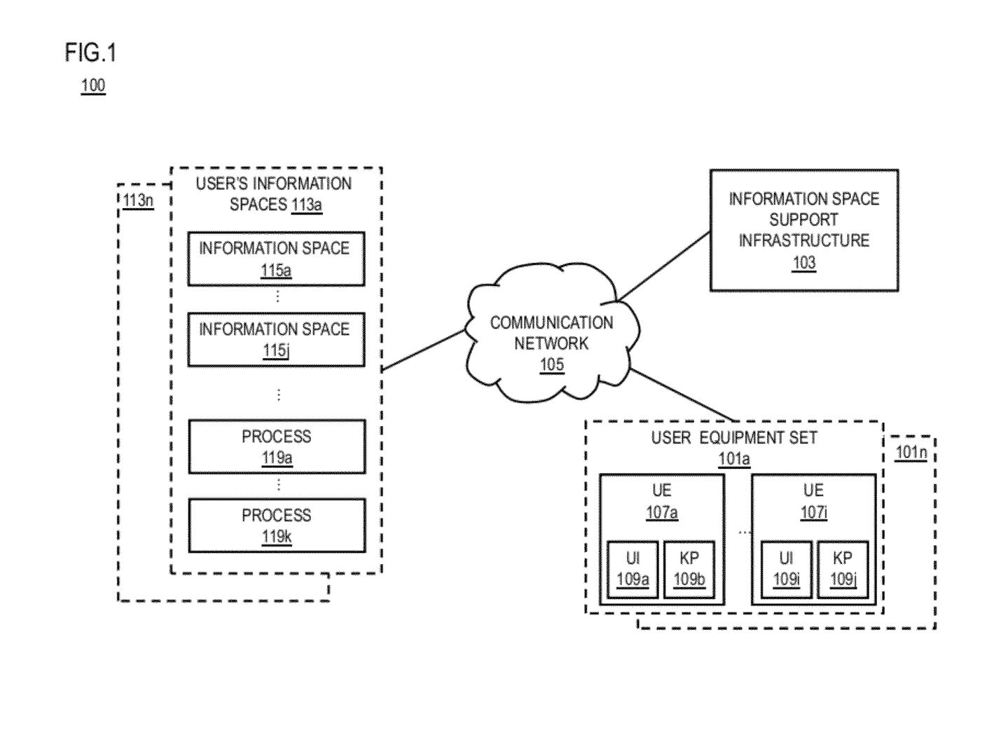

FIG. 1 is a diagram of a system capable of enabling interoperability among devices having access to a shared information space, according to one embodiment. An “information space” or “smart space,” in certain embodiments, refers to a network of aggregated information sets derived from different sources. Typically implemented to support distributed device and computing applications, information spaces are proving popular in Semantic Web, context gathering and personal information management situations because of their suitability to delineate or bound information on a per-scenario basis. In certain instances, information spaces may even be integrated for use in cloud computing environments and the like. Typically, an information space provides natural mechanisms for data distribution, privacy, trust, and information ownership within the context of a shared data environment. In addition, based upon general tuple-space principles, information spaces allow devices to interact with one another according to a known ontology—i.e., a defined schema for specifying the various contextual and semantic controls, structures, rules and mechanisms for supporting distributed computing and/or deployed software agent processing within the information space. A common ontology among devices is necessary for supporting data exchange and application processing to occur within a shared or distributed computing environment accessible to multiple different users.

The information within the information space is represented using Semantic Web standards such as Resource Description Framework (RDF), RDF Schema (RDFS), OWL (Web Ontology Language), FOAF (Friend-of-a-Friend ontology), rule sets in RuleML (Rule Markup Language), etc. Furthermore, as used herein, RDF refers to a family of World Wide Web Consortium (W3C) specifications originally designed as a metadata data model. It provides a general method for conceptual description or modeling of information that is implemented in web resources; using a variety of syntax formats. By way of these standards, several distributed devices may be implemented to include or access a knowledge processor (KP). In certain embodiments, KPs are executable components having instructions for communicating and exchanging information (e.g., RDF graphs) via a shared memory component of the information space known as a Semantic Information Broker (SIB). By way of example, a device within an information space may store information locally in its own memory space or publish information to the SIB for enabling access to the information by all devices. In the former scenario, the KP acting as an agent of the device is responsible for executing the processes for combining or extracting the information, while in the latter the processes are conducted by the SIB. The information can thus be organized as lists or sets of information that can include many data elements (e.g., a contact list, inventory of goods, business directory, etc.).

While use of information spaces to support distributed device applications is on the rise, the effectiveness of such distribution is hampered when the semantic compatibility of devices and/or information sources is compromised. By way of example, when a device employs a KP that operates in accord with its own ontology, the ability of the SIB of the information space or even another KP associated with another device is contingent upon the SIB's or the other KP's ability to interpret that ontology. The user or application request the KP is deployed to execute on behalf of the device (or application running on the device) cannot be executed without the existence of a common or matching ontology between all of the KPs and the SIB. Consequently, a methodology and framework for supporting such interoperability is needed. This is especially important for supporting mobile devices, where different devices having different KPs and ontology may need to interact with each other on-the-fly over an information space at any given moment.

To address this need, system 100 of FIG. 1 introduces the capability to enable knowledge processors (KPs), deployed by one or more user devices, to perform on-the-fly translation and interpretation between associated ontology. In addition, system 100 presents an ontology matching and or processing approach that is suitable for use within a distributed computing environment, i.e., by mobile devices; where minimal demand for processing or memory resources of the devices is required. By “on-the-fly” it is meant that the exemplary approaches prescribed herein may be implemented for use by any device operating within any information space at any given moment. This includes those instances where the device is in motion or when it comes in contact with various other devices and systems.

An information space support infrastructure 103 facilitates processing of information or computation closures in accordance an ontology matching process. This infrastructure 103 supports a KPs ability to retrieve and exchange information or execute specific application requests. In certain embodiments, “information closures” refer to primitive or basic representations of data within the information space. Also, “computation closures” may refer to relations and communications among various computations performed based on a given information closure, including activities such as passing arguments, sharing process results, data flow processing, etc. Typically, computation closures are processed within an information space in response to a specific application request or processing need of a requesting knowledge processor for a given user device.

As shown, system 100 comprises one or more sets 101a-101n of user equipment (UEs) UE 107a-107i, each having connectivity to the information space support infrastructure 103 via a communication network 105. By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UEs 107a-107i may be any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, Personal Digital Assistants (PDAs), audio/video player, digital camera/camcorder, positioning device, television receiver, radio broadcast receiver, electronic book device, game device, peripheral devices associated with such devices or any combination thereof. It is also contemplated that the UE 107a-107i can support any type of interface to the user (such as “wearable” circuitry, etc.).

In one embodiment, the UEs 107a-107i are equipped with one or more user interfaces (UIs) 109a-109i respectively. Each UI 109a-109i may consist of several UI elements (not shown) at any time, depending on the service or application being performed by respective UEs 107a-107i. UI elements may be icons representing user contexts such as information (e.g., music information, contact information, video information, etc.), functions (e.g., setup, search, etc.) and/or processes (e.g., download, play, edit, save, etc.). Additionally, each UI element may be bound to a context/process by granular migration. In certain instances, granular migration enables processes to be implicitly or explicitly migrated between devices, information spaces, and other infrastructure. The process migration can be initiated for example by means of single-cast (e.g., to just another UE 107) or multicast (e.g., to multiple other UEs 107). Still further, process migration may be triggered within the context of an information space via gesture recognition, wherein the user preselects a particular set of UI elements and makes a gesture to simulate “pouring” or transfer of the selected UE elements from one device to another.

In certain embodiments, UEs 107a-107i may also have operable thereon or have access to one or more knowledge processors (KPs) 109b-109j respectively. The KPs may be configured for operating within the information space to fulfill various user requests, device requests, application requests, or a combination thereof to provide a desired service within the information space for the user. As mentioned previously, KPs 109b-109j may or may not be configured to operate based on a common ontology. Still further, the ontology employed by respective KPs 109b-109i may or may not initially be intelligible by a semantic information broker (SIB), i.e., as supported by the information space support infrastructure 103. It will be seen later on that when an ontology is presented by a KP, the information space support infrastructure 103 may present techniques for enabling matching or translation of the ontology to permit execution of information closures, computation closures or combinations thereof.

As seen in FIG. 1, a user of UEs 107a-107i may own, use, or otherwise have access to various pieces of information distributed over a set 113a-113n of information spaces 115a-115j. Hence, it is noted that a specific user information space 113 set may encompass other information spaces 115, all of which provide access to specific data elements of interest to the user. Users having access to the user information space 113 can therefore retrieve, input, search for information or otherwise interact with respective information spaces 115a-115j via the UE set 101a consisting of UEs 107a-107i. By way of example, KPs 109b-109j may access the data as it is packaged as one or more information closures.

In certain embodiments, the sets of user information spaces 113a-113n may also be utilized as “computation spaces”—i.e., when one or more of the information spaces 115a-115j contain information closures that are required to be operated upon as one or more computation closures. When this is the case, each UE 107a-107i may have access to or operate upon one or more processes 119a-119k that can be used to manipulate the information stored in information spaces 115a-115j and produce results desired by the user of the UE 107. By way of example, KPs 109b-109j of respective devices may interact with the information space support infrastructure 103 to generate computation closures. The desired computation closures may then be presented to the user by way of UIs 109a-109i, such as in relation to a particular device application request. It is noted that the user information spaces 113a-113n are suitably configured, with the support of the information space support infrastructure 103, to enable information closure processing, computation closure processing, or a combination thereof.

In one embodiment, the information space support infrastructure 103 consists of information about computing closures to be formulated by way of processes 119a-119k for each UE 107a-107i. The information may include input parameters, input types and formats, output types and formats, process structure, data workflow types, communication means and parameter passing among processes 119a-119k, etc. The computation information enables a UE 107a-107i to divide computations into their primary computation closures, wherein each computation closure can be executed separately from other computation closures belonging to the same computation. For example, computations related to a music download may be divided into a search process for finding the most suitable download site, a verification process to determine whether the user is eligible for downloading from the site, an initialization process for verifying adequate resource (e.g. storage space) for the file to be downloaded, a process for verifying the type of the music file and associated playing environment, a process for determining whether the player is available on the UE 107, a process to activate the player after completion of the download, etc.

In one embodiment, the processes or computation closures derived from the processes may be executed independently from each other, i.e., by different devices, backend servers, etc. of the infrastructure 103. Following execution of the independent processes, data and parameters resulting from the execution can be exchanged and results aggregated to make for execution of the music application within the information space. In keeping with the above example, division of the music-related computations into independent processes may vary based on factors such characteristics of the UE, restrictions of the download site, the music file type, the player type and requirements, etc. In one embodiment, division of computations into their primary processes or computation closures may be managed by the information space support infrastructure 103.

By way of example, the UEs 107a-107i of sets 101a-101n, the information space support infrastructure 103, and sets of information spaces 113a-113n communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

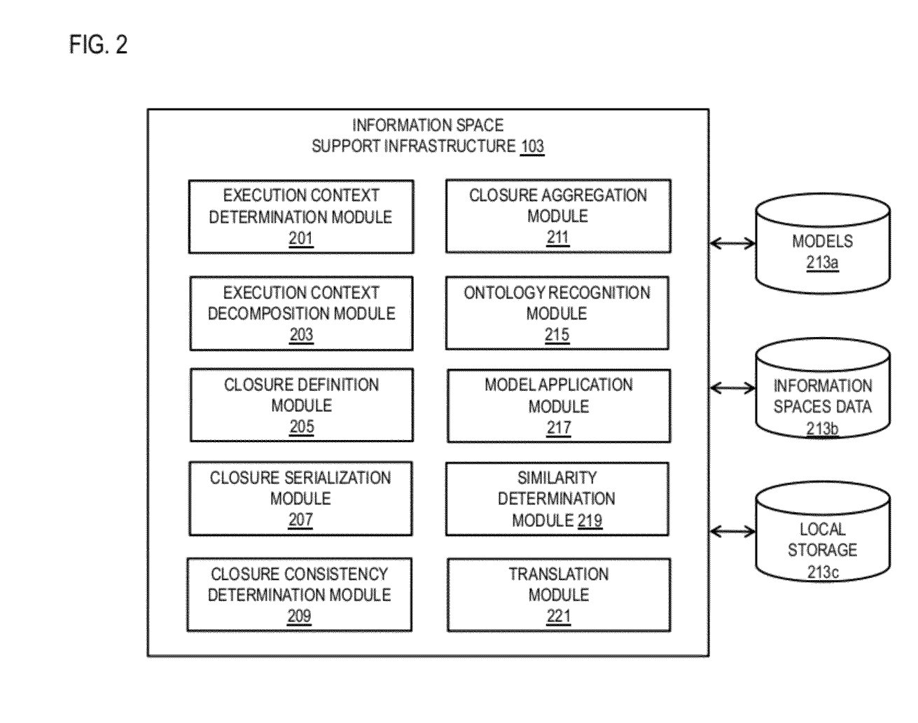

FIG. 2 is a diagram of the components of the information space support infrastructure, according to one embodiment. By way of example, the infrastructure 103 includes one or more components for construction and aggregation of distributed information or computations. Furthermore, the information space support infrastructure 103 is configured to support interoperability between different UEs 107a-107i, featuring differing resources and capabilities, having differing KPs 109b-109j. It is contemplated in certain embodiments that the functions of these components may be combined in one or more components or performed by other components of equivalent functionality. For the one embodiment, the information space support infrastructure 103 includes an execution context determination module 201, an execution context decomposition module 203, a closure definition module 205, a closure serialization module 207, a closure consistency determination module 209, a closure aggregation module 211, an ontology recognition module 215, a model application module 217, a similarity determination module 219 and a translation module 221. While not expressly shown, in certain embodiments it is contemplated that a user interface module may be provided for supporting UIs 109a-109i of respective UEs 107a-107i, a management module for enabling interaction of the various modules, etc.

The information space support infrastructure 103 receives requests for information or computation processing. By way of example, the request may be generated by a UE 107 based on a user gesture, i.e., pushing an icon of the UI 109 towards another UE 107 to indicate the user wants the process associated with the icon to be executed in the other UE 107. As another example, a request may be generated through a data entry process as facilitated by a keypad, keyboard, input screen or other data entry means of the UE 107a-107i. As yet another example, a request for computation or information processing can be generated by a component of an information space linked to the UE 107, by an independent component having connectivity to the UEs 107 and the information spaces via the communication network 105, or a combination thereof.

The request for computation or information processing may include details about the input, output, processing requirements, etc. The request may also specify data pertaining to the origin and destination of a computation or information process to be performed. For example, a user may want to distribute computations associated with encoding a video file from one format to another (a typically highly processor and resource intensive task). In this example, the video file is stored in the user's information space 115 or otherwise available over the communication network 105 (e.g., downloaded from a source over the Internet), and therefore accessible from the UEs 107. Accordingly, the user can make a manual request to distribute the computations associated with the video encoding to one or more other UEs, a backend server, cloud computing components and/or any other component capable of performing at least a portion of the encoding functions. By way of example, the manual request can be made via a graphical user interface by dragging an icon or other depiction of the computations to command areas depicted in the user interface. These command areas, for instance, may be representative of physical or virtual locations of the other UEs 107 that support or perform the distributed information processes or computations. In other cases, the distribution can be initiated automatically by the system 100 based on one or more criteria via a request generator (not shown) in conjunction with the information space support infrastructure 103.

In one embodiment, following receipt of an information or computation processing request, the execution context determination module 201 determines the execution components involved in retrieving the information or performing the computation. For the above example of encoding a video file from one format to another, the execution context may include retrieving video data, playing video or audio data, codec formatting, etc. and related settings, parameters, memory states, etc. The identified execution context may be stored in a local storage 213c, in a storage space associated with the information space 113a-113n, sent directly to the execution content decomposition module 203 or a combination thereof.

In another embodiment, the execution context decomposition module 203 breaks each execution context into its primitive or basic building blocks (e.g., primitive information or computation closures) or the sub-processes of the whole execution context. For example, the video data retrieval execution may be decomposed into information processing tasks such as accessing a database containing the video data. Likewise, the video playing execution may be decomposed into computations or processes that support tasks such as, searching for available players, checking the compatibility of video files with the players found, selecting the player, activating the selected player, etc. Each of the decomposed sub-processes may have certain specifications and requirements to effect execution of the processes in an information space 115 such as input and output medium and type, how parameters or results are to be passed to other processes, runtime environments, etc. In order for a process to be executed in a standalone fashion without being part of a larger process, information or computation closures can be generated for the process. A closure includes the process, specifications and requirements associated with the process that can be executed independently for subsequent aggregation.

In one embodiment, the closure definition module 205 generates closures for the sub-processes extracted by the execution context decomposition module 203 and stores the closures in local storage 213c. The stored closures may be used for slicing computations into smaller independent processes to be executed by various available UEs 107a-107i, using the data which may be stored on the distributed information spaces 115a-115j. In addition, closures can be encoded with specific functional data types based on processing rules that allow them to be chained together, such as to sequence closure processing or regulate the flow of retrieved information or computed processes. Also operating in connection with the closure definition module 205, in one embodiment a serialization module 207 utilizes the defined closures of module 205 and produces serialized granular closure elements. The closure serialization process as performed by module 207 can also execute data marshaling as is necessary for ensuring data format consistency within a distributed environment. Pursuant to the serialization process, the processing state of each closure is also encoded and stored in the user information space 113.

In one embodiment, the serialized closures may be generated and stored using Resource Description Framework (RDF) format. The underlying structure of any expression in RDF is a collection of triples, each consisting of three disjoint sets of nodes including a subject, a predicate and an object. A subject is an RDF URI reference (U) or a Blank Node (B), a predicate is an RDF URI reference (U), and an object is an RDF URI reference (U), a literal (L) or a Blank Node (B). A set of such triples is called an RDF graph. Table 1 shows an example RDF graph structure.

TABLE 1

| Subject | Predicate | Object |
|---|---|---|
| uri://....../rule#CD- | rdf:type, | uri://............/Rule |
| introduction, | | |
| uri://....../rule#CD- | uri://....../rule#assumption, | “c” |
| introduction, | | |

The granularity may be achieved by the basic format of operation (e.g. RDF) within the specific closure processing environment. Furthermore, reflectivity of processes (i.e. the capability of processes to provide a representation of their own behavior to be used for inspection and/or adaptation) may be achieved by encoding the behavior of the computation in RDF format. Additionally, the context may be assumed to be partly predetermined and stored as RDF in the user information space 113 and partly be extracted from the execution environment. It is noted that the RDF structures can be seen as subgraphs, RDF molecules (i.e., the building block of RDF graphs) or named graphs in the semantic information broker (SIB) of information spaces.

In certain embodiments, a closure consistency determination module 209 verifies the consistency of the closures which, as explained before, are in RDF graph format. The consistency verification ensures that the computation or information content for each closure is accurate, contains all the necessary information for execution and that the flow of data and instructions is correct according to the original computation and has not been damaged during the serialization and migration process. If the closures pass the consistency check or is otherwise approved, closure aggregation module 211 reconstructs each component of the execution context based on the content of the computation closures. Once an execution context is reconstructed, the agents of the run-time environment can resume the execution of the execution context component that it initially received as computation closures in RDF format. In one embodiment, the resumption of the execution may be combined with one or more other results of other executions of at least a portion of the execution context—i.e., aggregate multiple sets of retrieved information or the results of multiple performed computations.

In one embodiment, an ontology recognition module 215 recognizes whether a KP associated with a requesting UE 107a-107i correlates to the information space or not based on its presented ontology. As mentioned before, a KP operating as an agent on behalf of a user to fulfill a specific request will be configured according to a particular ontology defining the language, syntax, structure, attributes, relationships between other data elements, and other characteristics by which the KP interacts within an information space. In response to a request, presented as one or more closures, the ontology recognition module 215 accesses known ontology data maintained by information spaces database 213b. It then determines if the ontology presented by the KP correlates to a known ontology, at least to a predetermined degree defined within the information spaces data 213b. It is noted that the ability of the ontology recognition module 215 to correlate different ontology is based on an extent or degree of similarity (matching) of the ontology as determined by way of a similarity determination module 219. Still further, it is noted that the results of the closure consistency determination module 109 may be used to inform the recognition and correlation process.

In one embodiment, a similarity determination module 219 performs various techniques, approaches and metrics for determining an extent to which the ontology presented by the KP is similar to (or matches) an existing ontology maintained by the information space support infrastructure 103. By way of example, the information space support infrastructure 103 maintains one or more SIB ontology for comparison against requesting KPs. Some of the matching approaches are presented by way of example in Table 2 below:

TABLE 2

| Criteria | Possibilities/Requirements |
|---|---|
| Agent anonymity | Matching approach for different ontology |
| | Matching of different versions of the ontology |
| Information/knowledge | Format independent |
| representation format | RDF |
| | KIF |
| | Graph-based formats |
| Ontology aligned | Any |
| | Lightweight |
| | Large-scale |
| Automation | Semi-automatically |
| | Automatically |
| Algorithm complexity | High complexity |
| | Low complexity |
| | O(N2), N - the number of elements in the |
| | context of the concept to be matched |
| Precision | Supported |
| | N/A |
| Matching method class(es) | Contextual: |
| | distribution-based |
| | graph-based |
| | structural |
| | similarity structural propagation |
| | Linguistic: |
| | similarity-based |
| | Statistical: |
| | data type compatibility |
| | Combined: |
| | pattern-based |
| | heuristics |
| | rule-based |
| Usage of synonyms | No synonyms |
| | Synonyms supported: |
| | Thesaurus-based |
| | WordNet-based |
| Ontology element | One-to-one |
| matching | Any to any entities matching |
| | One to any entities matching supported |
| Internet usage | Internet is used |
| | Internet is not used |
| | Internet can be used |

The goal of ontology matching, as performed by the similarity determination module 219 in accordance with certain embodiments, is to address the following problems:
1. Ontology entities which have the same name can have different meaning.
2. Ontology entities which have different names can have the same meaning.
   For this purpose, a number of the above techniques can be applied, including:
1. Identification of synonyms
2. Similarity metrics (name similarity, linguistic similarity)
3. Heuristics (for example two nodes are likely to match if nodes in their neighborhood also match)
4. Compare sets of instances of classes instead compare classes
5. Rules: for example, if class Al related to class B1 (relation R1), A2 related to class B2 (relation R2) and B1 similar to B2, R1 similar to R2 therefore A1 similar to A2.
   As a result of matching, the following types of ontological element mapping proximities can be identified:
1. One-to-one mapping between the elements (e.g., Associate-Professor to Senior-Lecturer)
2. Between different types of elements (e.g., the relation AdvisedBy (Student, Professor) maps to the attribute advisor of the concept Student)
3. Complex type (e.g., Name maps to the concatenation of First Name and Last Name)

The similarity determination approaches above are based on the information retrieval metrics of precision and recall. Generally, for optimal characterization of an ontology within an information spaces, the false alignment approach (of Table 2) is avoided and precision metrics are preferred above recall metrics by appropriating a precise or optimal threshold value. Hence, the threshold/degree of matching of ontology is generated by the similarity determination module 219 using at least one of the above approaches or techniques, and shared with the ontology recognition module 215 for determining the extent of correlation between them. It is noted the ontological data maintained within the information spaces database 213b (e.g., acting as an SIB) for enabling similarity comparison to commence, should at least include data representative of the ontology of all participating KPs within the information space. Alternatively, it should at least maintain data representative of the ontology for the KP presented by the requesting device.

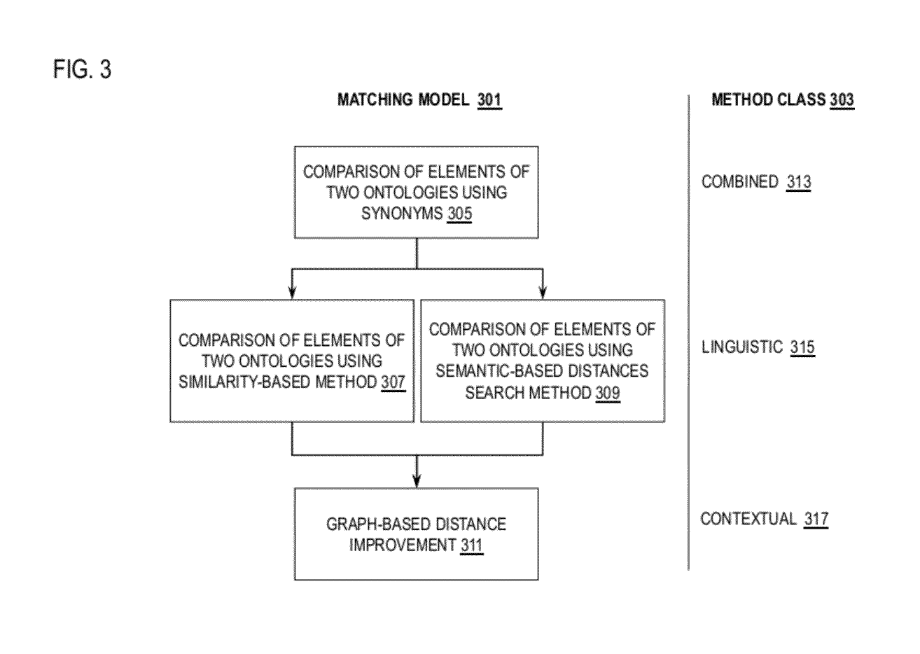

In one embodiment, a model application module 217 applies a plurality of comparison models, as maintained in a model database 213a, on the ontology presented by the requesting KP and the correlating ontology maintained by the information space support infrastructure 103. By way of example, the models applied enable matching of KPs and SIB ontology for maximizing interoperability, while at the same time addressing the need to enabling the matching procedure to be done on-the-fly by UEs (e.g., mobile devices) having limited resources. The KPs are responsible for performing certain concrete and well-described tasks, which means that the corresponding ontology generally should be small-to-medium size and describe only very limited domains. The model application module 217 therefore applies a corresponding model and workflow, as presented with respect to FIG. 3.

FIG. 3 is a diagram of a matching model for processing ontology within an information space, according to one embodiment. By way of example, the model comprises multiple matching approaches 305-311, which are executed against an ontology procedurally (e.g., from top-to-bottom). Ontology is represented as RDF triples, consisting of the following ontology elements: subject, predicate, object. The degree of similarity between ontology elements, as generated by the similarity determination module 219, is in the range [0, 1]. The approaches are performed as follows:
Approach 305: Compare ontology elements taking into account synonyms of both ontology (that of the KP and of the SIB—i.e., as maintained by the information space support infrastructure 103). The degree of similarity between equal elements is set to 1 (maximum value of the degree of similarity).
Approach 307: Compare all elements between the differing ontology and fill a matrix M using similarity-based modeling. Matrix M is of size m to n, where m is the number of elements in the first ontology (e.g., KP ontology) and n is the number of elements in the second ontology (e.g., SIB ontology). Each element of the matrix contains the degree of similarity between the string terms of two ontology elements using a stemming procedure.
   For similarity based modeling, in accordance with an embodiment, the stemming procedure is executed to normalize words and improve matching quality; enabling ontology elements to be identified even if they are written in different forms. By way of example, the following conversions can be done: “looking”→“look”, “device”→“devic”, “vertical”→“vertic”, and “horizontal”→“horizont”. Stemming can be tuned for each supported natural language. In addition, improved fuzzy string comparison can be employed for calculating the occurrence of substrings from one string in the other string. Still further, normalization may be performed in order to reduce the resulting similarity for easier interpretation.
Approach 309: For knowledge processors (KPs), which can access Internet, e.g., WordNet or Wiktionary, the approach of searching semantic distances is applied. By way of this approach, the model application module 217 calls for the comparison of all elements of the two ontologies and fill matrix M′. Matrix M′ is of size m to n, where m is the number of elements in the first ontology and n is the number of elements in the second ontology. Each element of the matrix represents the degree of similarity between two ontology elements. The approach then requires updating values in matrix M, where each new value of elements of M is the maximum of (M, M′).
Approach 311: Improve distance values in the matrix M using graph-based distance improvement modeling. By way of example, the graph-based improvement model is used for further propagation of similarities from one ontology element to another. The primary goal is to propagate the degree of similarity between closely matching ontology elements to ontology elements related to them through RDF triples. It is noted that algorithms may be applied for determining a propagating similarity distance to RDF subjects and objects as well as RDF predicates. The threshold value may also be factored in for determining the degree to which two ontology elements are mapped to each other (e.g., direct correlation, relative correlation, or a combination thereof).

As a result of approaches 305-311, matrix M contains degrees of similarity between ontology elements of two knowledge processors. This enables the determining of correspondences between elements. It is noted the various approaches of the matching model 301 correspond to respective method classes 303 as they are performed in a top-to-bottom fashion. By way of example, approach 305 corresponds to a combined method class 313, while approaches 307 and 309 (executed concurrently) correspond to a linguistic method class. Also, approach 311 of the matching model 301 corresponds to a contextual 317 method class 303. Linguistic methods are focused on determining similarity between entities based on linguistic comparison (e.g. count of the same symbols estimation, estimation of the longest similar parts of words, etc.), while contextual methods calculate a measure of similarity between entities based on their contexts. Combined methods employ all of the above.

It is noted, from the above described matching model 301, that the model application module 217 executes a multi-model approach suitable for enabling optimal execution of closures by UEs having limited resources. Accordingly, the model application module 217 also facilitates proper execution and handling of one or more information or computation closures in conjunction with the other described modules, as the closures are presented to the information space support infrastructure 103.

In accordance with one embodiment, a translation module 221 translates the one or more received information closures or computation closures associated with a given ontology of a KP or that of a SIB. The translation process is performed based on the degree of similarity between ontology, as determined by the similarity determination module 219. By way of example, when a correlation between ontology is determined to within a predetermined threshold, the translation module 221 can adapt various mapped/matched ontology elements (e.g., as rendered by the result set returned by the model application module 217) of one ontology to conform to that of another ontology.

It is noted the above described modules may rely upon or access information spaces data for enabling its various processing tasks. By way of example, the information spaces data 213b may include additional data useful for allowing respective UEs 107a-107i to engage within the information space 113 to perform computation or information processing. This may include one or more computation process models and schemes for supporting a specific type of computation task relative to a particular application, device or user profile data for characterizing the various users having access to the information space, heuristic data pertaining to activities, user devices, data or processes within operation of the information space 113, ontology data pertaining to the various KPs and SIBs supported by the information space, historical interaction data pertaining to various KPs, etc. As configured, the information space support infrastructure 103 is positioned to interact with the various KPs for enabling brokerage and exchange of information according to the semantic and contextual schema of the information space.

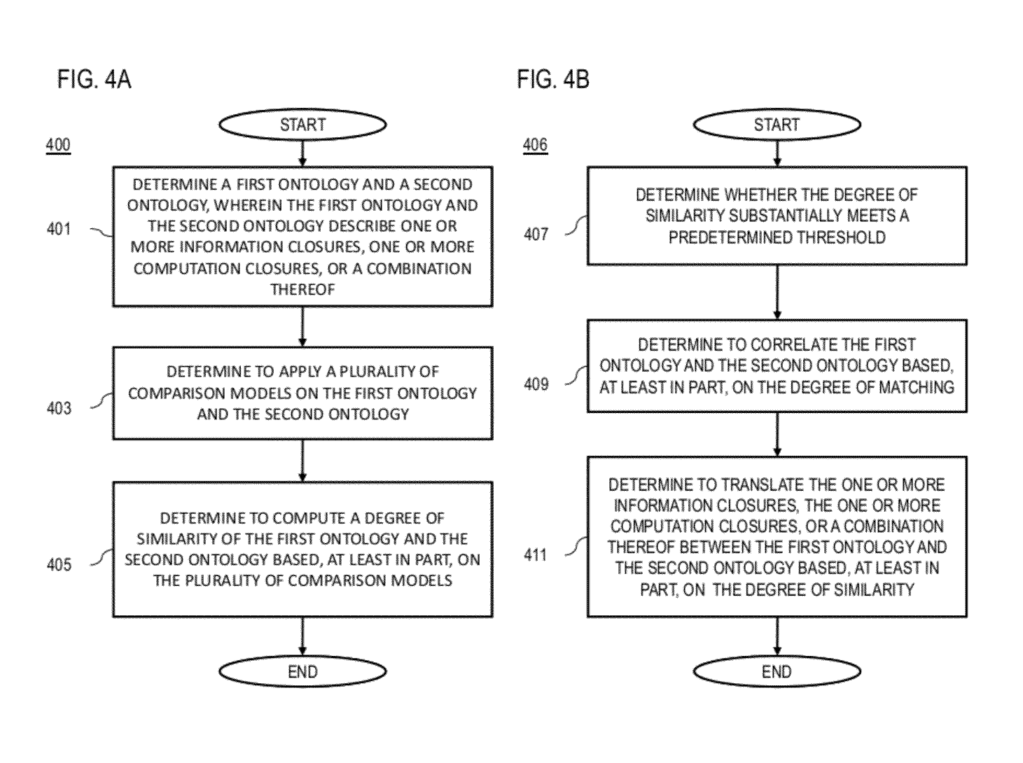

FIGS. 4A and 4B are flowcharts depicting processes for enabling interoperability among devices having access to a shared information space, according to various embodiments. For the purpose of illustration, the processes are described with respect to FIG. 1. It is noted that the steps of the process may be performed in any suitable order, as well as combined or separated in any suitable manner. In step 401 of process 400, a first ontology and a second ontology is determined. The ontology as they are presented to the information space support infrastructure 109 describes one or more information closures, one or more computation closures, or a combination thereof. In step 403, the information space support infrastructure 109 determines to apply a plurality of comparison models, i.e., the matching model 301 of FIG. 3, on the first and second ontology. In another step 405, a degree of similarity of the first and the second ontology is determined. As mentioned previously, the degree of similarity (matching) between modules may be based, at least in part, on the results of the applied comparison models. Also, the plurality of comparison models may be synonym models, similarity models, distances models or a combination thereof. It is noted that the comparison models may be selected based on context information associated with a given KP and/or SIB as associated with respective closures, or a combination thereof.

With reference now to FIG. 4B, in step 407 of process 406, a determination is made as to whether the degree of similarity between ontology substantially meets a predetermined threshold. In step 409, it is determined to correlate the first ontology and the second ontology. As mentioned previously, the correlation is carried out by the ontology recognition module 215 of the information space support infrastructure 103. Correlations are based in part on the degree of matching between the ontology. In another step 411, it is determined to translate the one or more information closures, computation closures or a combination thereof between the first ontology and the second ontology. Translation, as performed by the translation module 221 of the information space support infrastructure 103, is based at least in part on the determined degree of similarity between ontology.

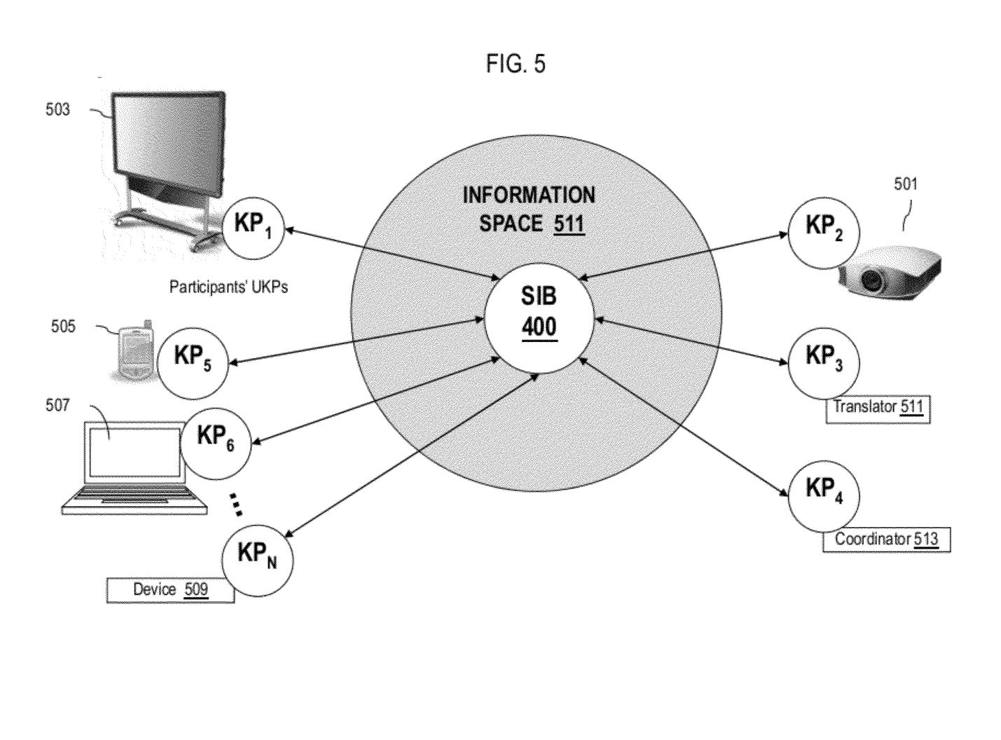

FIGS. 5, 6, 7A and 7B are diagrams depicting an interaction between a semantic information broker and one or more knowledge processors for executing the processes of FIGS. 4A and 4B, according to various embodiments. By way of example, FIG. 5 presents an exemplary use scenario and environment for depicting application of the aforementioned processes and approaches. The scenario involves a meeting or classroom setting that takes place in an “intelligent room” equipped with LCD projector 501, whiteboard 503 and has access to Internet services (e.g. to allow on-the-fly/on-demand translation of meeting materials to any language using existing Internet-services). While not shown expressly, it may be assumed that a network channel, communication port, or other connectivity means is configured to respective devices 501 and 503.

Under this scenario, users that are planning to deliver a presentation within the intelligent room have knowledge processors—called User Knowledge Processor (UKP)—installed on their mobile devices. In certain instances, the UKPs are accessed by some direct access means. Device types employed by respective users in this example include a smartphone 505, a laptop 507 and any other device 509. When a user enters the intelligent meeting room, characterized for access over a network as an information space 511, the UKPs associated with the devices, namely KP₁-KP_{N} may present the following to the information space support infrastructure 103:
user profile information (name, photo, domain of interests, e-mail, and phone number, etc.);
presentation information (title, keywords, uniform resource identifier (URI)).

Before the meeting starts, the agenda is automatically built and shown on the whiteboard 503 including presentment of the speakers' names, photos and presentation titles. Current presentation data is highlighted, and all participants of the intelligent room information space 511 can see the detailed agenda on the screens of their respective personal mobile devices (e.g., 505-509). A graphical user interface (GUI) for visualizing the detailed agenda on the display of participants' KP-enabled devices is executed.

Users can also change their user profile items via a graphical user interface of their device as rendered respective to the information space 511. Under this scenario, when the user changes the information about his/her presentation in the profile, the UKP associated with that user's device KP₅-KP_{N} changes the appropriate rules in the information space. At the scheduled time of the lecture, meeting or presentation, coordinated/intelligent actions begin to occur automatically as arranged appropriated via the information space support infrastructure for the intelligent meeting room. By way of example, the LCD projector 501 is switched ON and the appropriate presentation is retrieved, opened and shown on the whiteboard 503. In addition, the user can control the presentation slides directly from their mobile device as it accesses the information space. As yet another example, five minutes before the presentation is scheduled to end, the whiteboard presents a reminder to the speaker about the time restrictions, and displays a countdown timer. It is noted that the above described scenario is executed via interaction between one or more KPs associated with one or more devices and an SIB 400 associated with the information space 511, wherein the processes and/or data procedures are rendered as one or more computation or information closures. The scenario as presented includes the following knowledge processors (KPs):
KP₁—associated with the whiteboard (e.g., personal computer (PC) based or digital standalone 503)
KP₂—projector (e.g., 501)
KP₃—translator 511 (e.g., software executable by PC or accessed via Internet service)
KP₄—coordinator 513 (e.g., PC)
KP₅ . . . _{N}—UKPs (e.g., smartphone 505, laptop 507, other device 509)

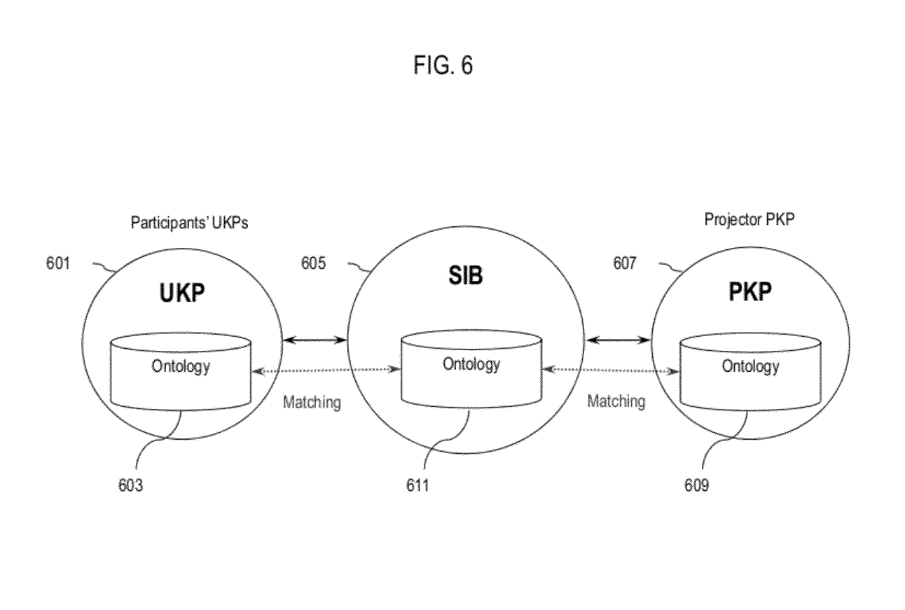

Application of the matching procedure, as performed with respect to FIGS. 4A-4B, is presented in one embodiment with respect to FIG. 6. Participating devices executed user KPs (UKPs) 601, each having an associated ontology 603 through which they interact with an information space 605. Likewise, a projector KP (PKP) 607, as executed by the projector, enables it to interact within the information space via an SIB 605 in accordance with ontology 609. As stated previously, the information space may be supported by the information space support infrastructure 103 exchanging and brokering data between UKPs 601 and PKP 607 (e.g., as a SIB 605 with associated ontology 611). Also, matching of ontology may be performed via the support of the information space support infrastructure 103, as represented by the dashed arrows depicting the matching/mapping of ontology.

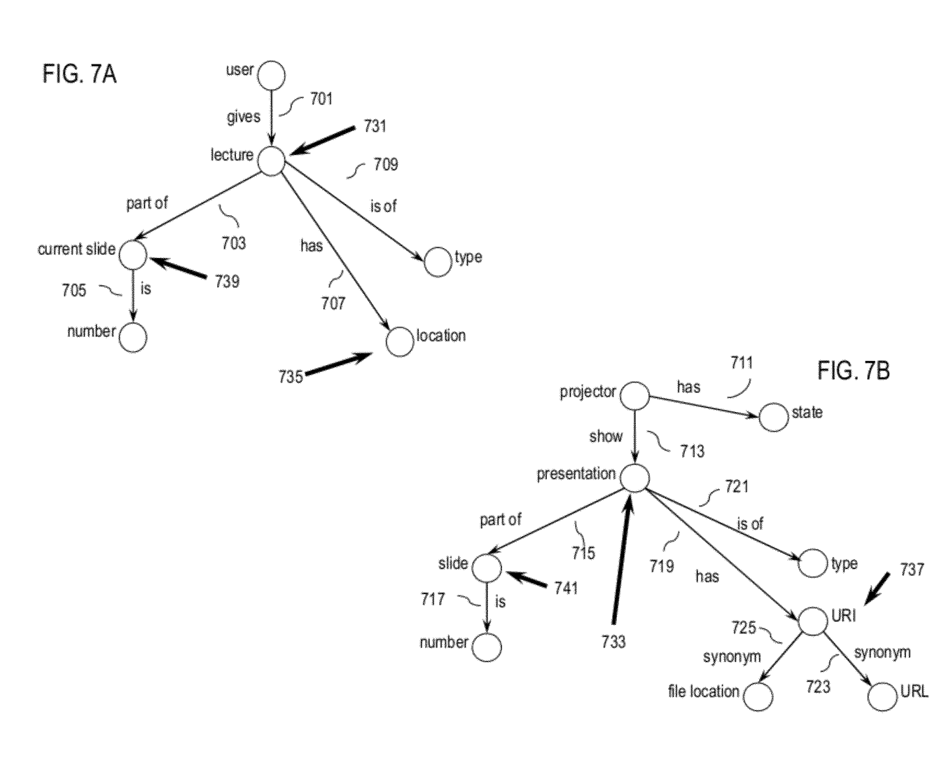

By way of example, it is assumed the user having a mobile device with a UKP 601 running on it is going to present material for a lecture within the context of the information space. The corresponding ontology is presented in FIGS. 7A and 7B. In one embodiment, the following ontology describes the UKP interaction within the SIB within the information space for giving a lecture, presented as one or more sequences and arrangements of RDF triples:

(“user”, “gives”, “lecture”)—corresponding to ontological stem 701

(“current slide”, “part of”, “lecture”)—corresponding to ontological stem 703

(“current slide”, “is”, “Number”)—corresponding to ontological stem 705

(“lecture”, “has”, “Location”)—corresponding to ontological stem 707

(“lecture”, “is of”, “Type”)—corresponding to ontological stem 709

The LCD projector 501 is represented in the information space by the projector KP (PKP) 607. In order for the presentation to be shown, the UKP 601 has to share the information about the presentation location (e.g., URI) with PKP 607. In one embodiment, the ontology of the PKP 607 is presented with respect to FIG. 7B. The description of corresponding projector ontology is presented below:

(“projector”, “has”, “state”)—corresponding to ontological stem 711

(“projector”, “show”, “presentation”)—corresponding to ontological stem 713

(“slide”, “part of”, “presentation”)—corresponding to ontological stem 715

(“slide”, “is”, “Number”)—corresponding to ontological stem 717

(“presentation”, “has”, “URI”)—corresponding to ontological stem 719

(“presentation”, “is of”, “Type”)—corresponding to ontological stem 721

(“URL”, “synonym”, “URI”)—corresponding to ontological stem 723

(“file location”, “synonym”, “URI”)—corresponding to ontological stem 725

Having determined the first and second ontology as presented to the information space, corresponding to the UKP and PKP respectively, the information space support infrastructure (e.g., for enabling SIB 605) may perform various analysis and procedures. By way of example, the UKP 601 and PKP 607 ontology 603 and 609 respectively, can be merged, resulting in:
Ontologic element “lecture” 731 from the UKP ontology 603 is merged with the “presentation” element 733 from PKP ontology 609 as a result of the semantic-based distances search method—i.e., as performed by application of the matching model 301 to the ontology via the model application module 217. By way of example, the distance between these elements is 0.3;
The element “location” 735 from UKP ontology 603 is merged with the ontological element “URI” 737 from PKP ontology 609 as a result of checking the synonym rules of the PKP ontology 609;
The element “Current slide” 739 is merged with the ontological element “Slide” 741. The degree of similarity between these elements as estimated via fuzzy string comparison, as performed via the model application module 217, is 0.58.

As a result of this matching process, the information space support infrastructure interacts with UKP 601 to enable it to determine that the following rule has to be added to the smart space to start the lecture:

(“URI”, “is”, “http://example.com/presentation1.ppt”)

It is noted the above described processes, techniques and system may enables multiple different devices to more effectively interact with one another within an information space despite having differing ontology. The multi-model matching approach, as described, allows ontology to be analyzed for fast and efficient correlation and subsequent matching, which is particularly suitable for mobile device application having limited processing resources. Also, the information space support infrastructure 103 presents various modules for optimizing the interaction between participating knowledge processors and semantic information brokers to facilitate both information and computation closure processing. Still further, ontology may be correlated and translated to enable closure processing and facilitate interoperability among differing KPs with an on-the-fly, distributed computing environment.

The processes described herein for enabling interoperability among devices having access to a shared information space may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

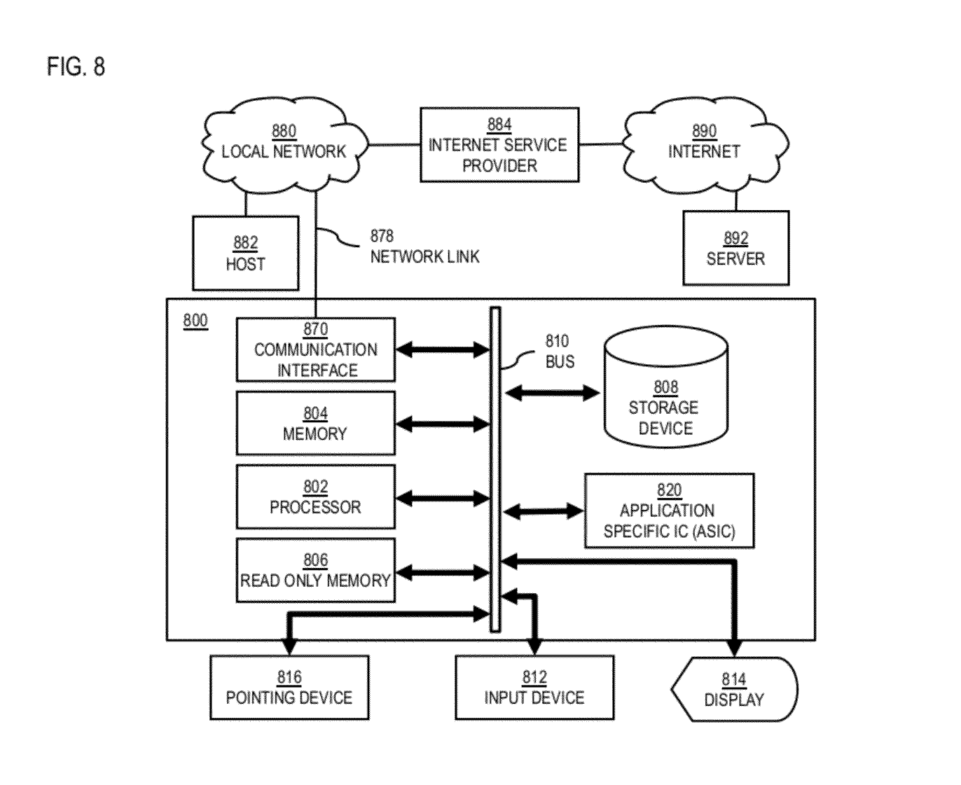

FIG. 8 illustrates a computer system 800 upon which an embodiment of the invention may be implemented. Although computer system 800 is depicted with respect to a particular device or equipment, it is contemplated that other devices or equipment (e.g., network elements, servers, etc.) within FIG. 8 can deploy the illustrated hardware and components of system 800. Computer system 800 is programmed (e.g., via computer program code or instructions) to enable interoperability among devices having access to a shared information space as described herein and includes a communication mechanism such as a bus 810 for passing information between other internal and external components of the computer system 800. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 800, or a portion thereof, constitutes a means for performing one or more steps of enabling interoperability among devices having access to a shared information space.

A bus 810 includes one or more parallel conductors of information so that information is transferred quickly among devices coupled to the bus 810. One or more processors 802 for processing information are coupled with the bus 810.

A processor (or multiple processors) 802 performs a set of operations on information as specified by computer program code related to enabling interoperability among devices having access to a shared information space. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 810 and placing information on the bus 810. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 802, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 800 also includes a memory 804 coupled to bus 810. The memory 804, such as a random access memory (RAM) or any other dynamic storage device, stores information including processor instructions for enabling interoperability among devices having access to a shared information space. Dynamic memory allows information stored therein to be changed by the computer system 800. RAM allows a unit of information stored at a location called a memory address to be stored and retrieved independently of information at neighboring addresses. The memory 804 is also used by the processor 802 to store temporary values during execution of processor instructions. The computer system 800 also includes a read only memory (ROM) 806 or any other static storage device coupled to the bus 810 for storing static information, including instructions, that is not changed by the computer system 800. Some memory is composed of volatile storage that loses the information stored thereon when power is lost. Also coupled to bus 810 is a non-volatile (persistent) storage device 808, such as a magnetic disk, optical disk or flash card, for storing information, including instructions, that persists even when the computer system 800 is turned off or otherwise loses power.

Information, including instructions for enabling interoperability among devices having access to a shared information space, is provided to the bus 810 for use by the processor from an external input device 812, such as a keyboard containing alphanumeric keys operated by a human user, or a sensor. A sensor detects conditions in its vicinity and transforms those detections into physical expression compatible with the measurable phenomenon used to represent information in computer system 800. Other external devices coupled to bus 810, used primarily for interacting with humans, include a display device 814, such as a cathode ray tube (CRT), a liquid crystal display (LCD), a light emitting diode (LED) display, an organic LED (OLED) display, a plasma screen, or a printer for presenting text or images, and a pointing device 816, such as a mouse, a trackball, cursor direction keys, or a motion sensor, for controlling a position of a small cursor image presented on the display 814 and issuing commands associated with graphical elements presented on the display 814. In some embodiments, for example, in embodiments in which the computer system 800 performs all functions automatically without human input, one or more of external input device 812, display device 814 and pointing device 816 is omitted.

In the illustrated embodiment, special purpose hardware, such as an application specific integrated circuit (ASIC) 820, is coupled to bus 810. The special purpose hardware is configured to perform operations not performed by processor 802 quickly enough for special purposes. Examples of ASICs include graphics accelerator cards for generating images for display 814, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 800 also includes one or more instances of a communications interface 870 coupled to bus 810. Communication interface 870 provides a one-way or two-way communication coupling to a variety of external devices that operate with their own processors, such as printers, scanners and external disks. In general the coupling is with a network link 878 that is connected to a local network 880 to which a variety of external devices with their own processors are connected. For example, communication interface 870 may be a parallel port or a serial port or a universal serial bus (USB) port on a personal computer. In some embodiments, communications interface 870 is an integrated services digital network (ISDN) card or a digital subscriber line (DSL) card or a telephone modem that provides an information communication connection to a corresponding type of telephone line. In some embodiments, a communication interface 870 is a cable modem that converts signals on bus 810 into signals for a communication connection over a coaxial cable or into optical signals for a communication connection over a fiber optic cable. As another example, communications interface 870 may be a local area network (LAN) card to provide a data communication connection to a compatible LAN, such as Ethernet. Wireless links may also be implemented. For wireless links, the communications interface 870 sends or receives or both sends and receives electrical, acoustic or electromagnetic signals, including infrared and optical signals, that carry information streams, such as digital data. For example, in wireless handheld devices, such as mobile telephones like cell phones, the communications interface 870 includes a radio band electromagnetic transmitter and receiver called a radio transceiver. In certain embodiments, the communications interface 870 enables connection to the communication network 105 for enabling interoperability among devices having access to a shared information space to the UE 101.

The term “computer-readable medium” as used herein refers to any medium that participates in providing information to processor 802, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 808. Volatile media include, for example, dynamic memory 804. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 820.

Network link 878 typically provides information communication using transmission media through one or more networks to other devices that use or process the information. For example, network link 878 may provide a connection through local network 880 to a host computer 882 or to equipment 884 operated by an Internet Service Provider (ISP). ISP equipment 884 in turn provides data communication services through the public, world-wide packet-switching communication network of networks now commonly referred to as the Internet 890.

A computer called a server host 892 connected to the Internet hosts a process that provides a service in response to information received over the Internet. For example, server host 892 hosts a process that provides information representing video data for presentation at display 814. It is contemplated that the components of system 800 can be deployed in various configurations within other computer systems, e.g., host 882 and server 892.

At least some embodiments of the invention are related to the use of computer system 800 for implementing some or all of the techniques described herein. According to one embodiment of the invention, those techniques are performed by computer system 800 in response to processor 802 executing one or more sequences of one or more processor instructions contained in memory 804. Such instructions, also called computer instructions, software and program code, may be read into memory 804 from another computer-readable medium such as storage device 808 or network link 878. Execution of the sequences of instructions contained in memory 804 causes processor 802 to perform one or more of the method steps described herein. In alternative embodiments, hardware, such as ASIC 820, may be used in place of or in combination with software to implement the invention. Thus, embodiments of the invention are not limited to any specific combination of hardware and software, unless otherwise explicitly stated herein.

The signals transmitted over network link 878 and other networks through communications interface 870, carry information to and from computer system 800. Computer system 800 can send and receive information, including program code, through the networks 880, 890 among others, through network link 878 and communications interface 870. In an example using the Internet 890, a server host 892 transmits program code for a particular application, requested by a message sent from computer 800, through Internet 890, ISP equipment 884, local network 880 and communications interface 870. The received code may be executed by processor 802 as it is received, or may be stored in memory 804 or in storage device 808 or any other non-volatile storage for later execution, or both. In this manner, computer system 800 may obtain application program code in the form of signals on a carrier wave.

Various forms of computer readable media may be involved in carrying one or more sequence of instructions or data or both to processor 802 for execution. For example, instructions and data may initially be carried on a magnetic disk of a remote computer such as host 882. The remote computer loads the instructions and data into its dynamic memory and sends the instructions and data over a telephone line using a modem. A modem local to the computer system 800 receives the instructions and data on a telephone line and uses an infra-red transmitter to convert the instructions and data to a signal on an infra-red carrier wave serving as the network link 878. An infrared detector serving as communications interface 870 receives the instructions and data carried in the infrared signal and places information representing the instructions and data onto bus 810. Bus 810 carries the information to memory 804 from which processor 802 retrieves and executes the instructions using some of the data sent with the instructions. The instructions and data received in memory 804 may optionally be stored on storage device 808, either before or after execution by the processor 802.

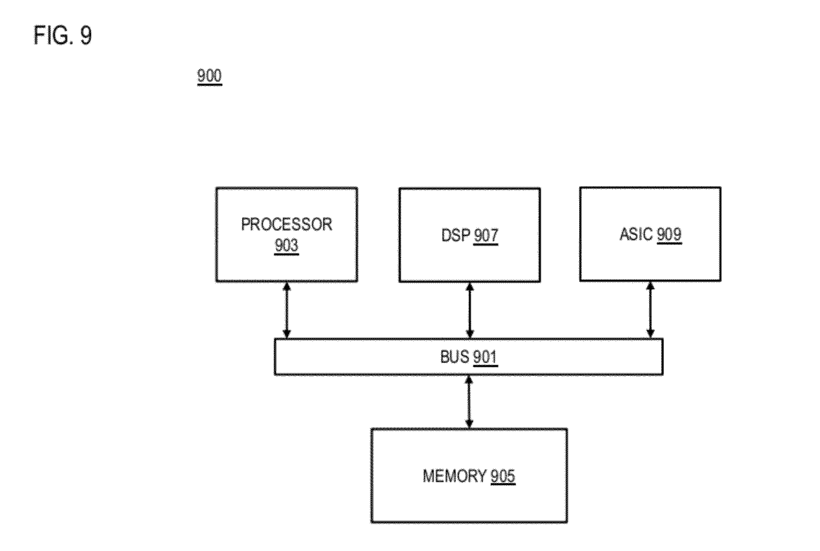

FIG. 9 illustrates a chip set or chip 900 upon which an embodiment of the invention may be implemented. Chip set 900 is programmed to enable interoperability among devices having access to a shared information space as described herein and includes, for instance, the processor and memory components described with respect to FIG. 8 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 900 can be implemented in a single chip. It is further contemplated that in certain embodiments the chip set or chip 900 can be implemented as a single “system on a chip.” It is further contemplated that in certain embodiments a separate ASIC would not be used, for example, and that all relevant functions as disclosed herein would be performed by a processor or processors. Chip set or chip 900, or a portion thereof, constitutes a means for performing one or more steps of providing user interface navigation information associated with the availability of functions. Chip set or chip 900, or a portion thereof, constitutes a means for performing one or more steps of enabling interoperability among devices having access to a shared information space.

In one embodiment, the chip set or chip 900 includes a communication mechanism such as a bus 901 for passing information among the components of the chip set 900. A processor 903 has connectivity to the bus 901 to execute instructions and process information stored in, for example, a memory 905. The processor 903 may include one or more processing cores with each core configured to perform independently. A multi-core processor enables multiprocessing within a single physical package. Examples of a multi-core processor include two, four, eight, or greater numbers of processing cores. Alternatively or in addition, the processor 903 may include one or more microprocessors configured in tandem via the bus 901 to enable independent execution of instructions, pipelining, and multithreading. The processor 903 may also be accompanied with one or more specialized components to perform certain processing functions and tasks such as one or more digital signal processors (DSP) 907, or one or more application-specific integrated circuits (ASIC) 909. A DSP 907 typically is configured to process real-world signals (e.g., sound) in real time independently of the processor 903. Similarly, an ASIC 909 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 900 includes merely one or more processors and some software and/or firmware supporting and/or relating to and/or for the one or more processors.

The processor 903 and accompanying components have connectivity to the memory 905 via the bus 901. The memory 905 includes both dynamic memory (e.g., RAM, magnetic disk, writable optical disk, etc.) and static memory (e.g., ROM, CD-ROM, etc.) for storing executable instructions that when executed perform the inventive steps described herein to enable interoperability among devices having access to a shared information space. The memory 905 also stores the data associated with or generated by the execution of the inventive steps.

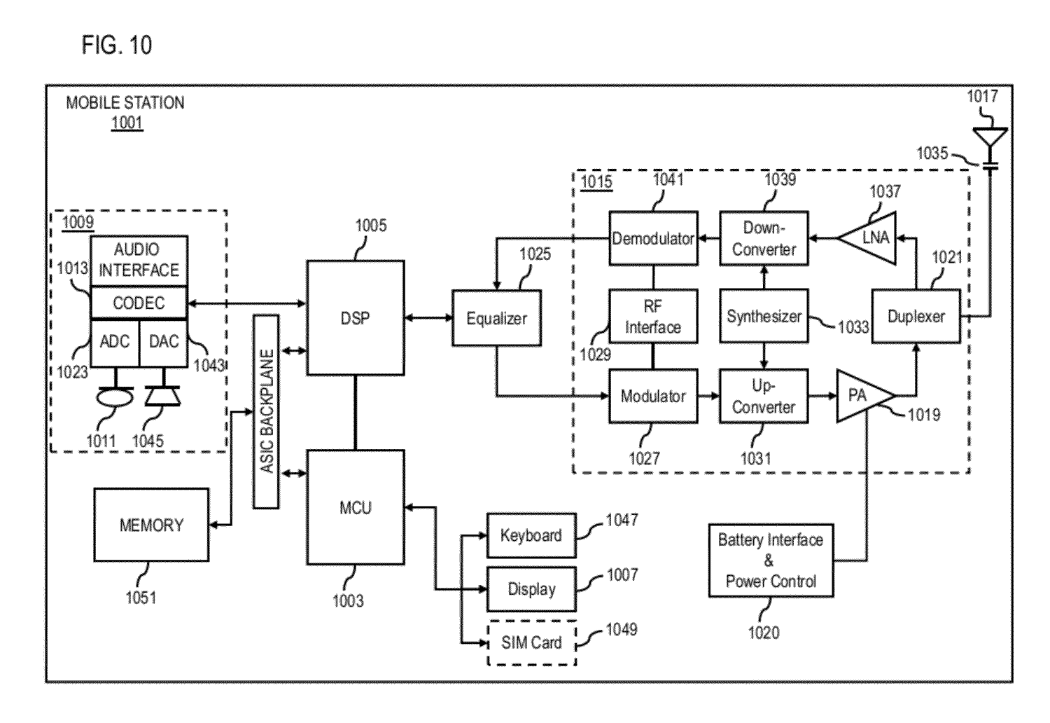

FIG. 10 is a diagram of exemplary components of a mobile terminal (e.g., handset) for communications, which is capable of operating in the system of FIG. 1, according to one embodiment. In some embodiments, mobile terminal 1001, or a portion thereof, constitutes a means for performing one or more steps of enabling interoperability among devices having access to a shared information space. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1003, a Digital Signal Processor (DSP) 1005, and a receiver/transmitter unit including a microphone gain control unit and a speaker gain control unit. A main display unit 1007 provides a display to the user in support of various applications and mobile terminal functions that perform or support the steps of enabling interoperability among devices having access to a shared information space. The display 1007 includes display circuitry configured to display at least a portion of a user interface of the mobile terminal (e.g., mobile telephone). Additionally, the display 1007 and display circuitry are configured to facilitate user control of at least some functions of the mobile terminal. An audio function circuitry 1009 includes a microphone 1011 and microphone amplifier that amplifies the speech signal output from the microphone 1011. The amplified speech signal output from the microphone 1011 is fed to a coder/decoder (CODEC) 1013.

A radio section 1015 amplifies power and converts frequency in order to communicate with a base station, which is included in a mobile communication system, via antenna 1017. The power amplifier (PA) 1019 and the transmitter/modulation circuitry are operationally responsive to the MCU 1003, with an output from the PA 1019 coupled to the duplexer 1021 or circulator or antenna switch, as known in the art. The PA 1019 also couples to a battery interface and power control unit 1020.

In use, a user of mobile terminal 1001 speaks into the microphone 1011 and his or her voice along with any detected background noise is converted into an analog voltage. The analog voltage is then converted into a digital signal through the Analog to Digital Converter (ADC) 1023. The control unit 1003 routes the digital signal into the DSP 1005 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1025 for compensation of any frequency-dependent impairments that occur during transmission though the air such as phase and amplitude distortion. After equalizing the bit stream, the modulator 1027 combines the signal with a RF signal generated in the RF interface 1029. The modulator 1027 generates a sine wave by way of frequency or phase modulation. In order to prepare the signal for transmission, an up-converter 1031 combines the sine wave output from the modulator 1027 with another sine wave generated by a synthesizer 1033 to achieve the desired frequency of transmission. The signal is then sent through a PA 1019 to increase the signal to an appropriate power level. In practical systems, the PA 1019 acts as a variable gain amplifier whose gain is controlled by the DSP 1005 from information received from a network base station. The signal is then filtered within the duplexer 1021 and optionally sent to an antenna coupler 1035 to match impedances to provide maximum power transfer. Finally, the signal is transmitted via antenna 1017 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1001 are received via antenna 1017 and immediately amplified by a low noise amplifier (LNA) 1037. A down-converter 1039 lowers the carrier frequency while the demodulator 1041 strips away the RF leaving only a digital bit stream. The signal then goes through the equalizer 1025 and is processed by the DSP 1005. A Digital to Analog Converter (DAC) 1043 converts the signal and the resulting output is transmitted to the user through the speaker 1045, all under control of a Main Control Unit (MCU) 1003 which can be implemented as a Central Processing Unit (CPU) (not shown).

The MCU 1003 receives various signals including input signals from the keyboard 1047. The keyboard 1047 and/or the MCU 1003 in combination with other user input components (e.g., the microphone 1011) comprise a user interface circuitry for managing user input. The MCU 1003 runs a user interface software to facilitate user control of at least some functions of the mobile terminal 1001 to enable interoperability among devices having access to a shared information space. The MCU 1003 also delivers a display command and a switch command to the display 1007 and to the speech output switching controller, respectively. Further, the MCU 1003 exchanges information with the DSP 1005 and can access an optionally incorporated SIM card 1049 and a memory 1051. In addition, the MCU 1003 executes various control functions required of the terminal. The DSP 1005 may, depending upon the implementation, perform any of a variety of conventional digital processing functions on the voice signals. Additionally, DSP 1005 determines the background noise level of the local environment from the signals detected by microphone 1011 and sets the gain of microphone 1011 to a level selected to compensate for the natural tendency of the user of the mobile terminal 1001.

The CODEC 1013 includes the ADC 1023 and DAC 1043. The memory 1051 stores various data including call incoming tone data and is capable of storing other data including music data received via, e.g., the global Internet. The software module could reside in RAM memory, flash memory, registers, or any other form of writable storage medium known in the art. The memory device 1051 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1049 carries, for instance, important information, such as the cellular phone number, the carrier supplying service, subscription details, and security information. The SIM card 1049 serves primarily to identify the mobile terminal 1001 on a radio network. The card 1049 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising:
determining a first ontology and a second ontology, wherein the first ontology and the second ontology describe one or more information closures, one or more computation closures, or a combination thereof;
determining to apply a plurality of comparison models on the first ontology and the second ontology; and
determining to compute a degree of similarity of the first ontology and the second ontology based, at least in part, on the plurality of comparison models.

2. A method of claim 1, further comprising:
determining to correlate the first ontology and the second ontology based, at least in part, on the degree of similarity.

3. A method of claim 2, further comprising:
determining whether the degree of similarity substantially meets a predetermined threshold,
wherein the correlation of the first ontology and the second ontology is further based, at least in part, on the determination with respect to the predetermined threshold.

4. A method of claim 2, wherein the correlation includes a direct correlation, a relative correlation, or a combination thereof.

5. A method of claim 1, further comprising:
determining to translate the one or more information closures, the one or more computation closures, or a combination thereof between the first ontology and the second ontology based, at least in part, on the degree of similarity.

6. A method of claim 1, wherein the first ontology and the second ontology are associated with one or more information spaces, one or more computation spaces, or a combination thereof.

7. A method of claim 6, further comprising:
receiving an input specifying an operation with respect to the one or more spaces; and
determining to trigger the computing of the degree of matching based, at least in part, on the input.

8. A method of claim 6, wherein the first ontology is associated with a first component of the one or more information spaces and the second ontology is associated with a second component of the one or more information spaces.

9. A method of claim 8, wherein the first component, the second component, or both are a knowledge processor or a semantic information broker.

10. A method of claim 9, further comprising:
determining to select the plurality of comparison models based, at least in part, on context information associated with knowledge processor, the semantic information broker, or a combination thereof.

11. A method of claim 1, wherein the plurality of comparison models include, at least in part, one or more synonym models, one or more similarity models, one or more distance models, or a combination thereof.

12. A method of claim 1, wherein the degree of similarity is expressed as a matrix of one or more results of the application of the plurality of comparison models.

13. An apparatus comprising:
at least one processor; and
at least one memory including computer program code for one or more programs,
the at least one memory and the computer program code configured to, with the at least one processor, cause the apparatus to perform at least the following,
determine a first ontology and a second ontology, wherein the first ontology and the second ontology describe one or more information closures, one or more computation closures, or a combination thereof;
determine to apply a plurality of comparison models on the first ontology and the second ontology; and
determine to compute a degree of similarity of the first ontology and the second ontology based, at least in part, on the plurality of comparison models.

14. An apparatus of claim 13, wherein the apparatus is further caused to:
determining to correlate the first ontology and the second ontology based, at least in part, on the degree of similarity.

15. An apparatus of claim 14, wherein the apparatus is further caused to:
determining whether the degree of similarity substantially meets a predetermined threshold,
wherein the correlation of the first ontology and the second ontology is further based, at least in part, on the determination with respect to the predetermined threshold.

16. An apparatus of claim 14, wherein the correlation includes a direct correlation, a relative correlation, or a combination thereof.

17. An apparatus of claim 13, wherein the apparatus is further caused to:
determining to translate the one or more information closures, the one or more computation closures, or a combination thereof between the first ontology and the second ontology based, at least in part, on the degree of similarity.

18. An apparatus of claim 13, wherein the first ontology and the second ontology are associated with one or more information spaces, one or more computation spaces, or a combination thereof.

19. An apparatus of claim 18, wherein the apparatus is further caused to:
receiving an input specifying an operation with respect to the one or more spaces; and
determining to trigger the computing of the degree of matching based, at least in part, on the input.

20. An apparatus of claim 18, wherein the first ontology is associated with a first component of the one or more information spaces and the second ontology is associated with a second component of the one or more information spaces.

21.-49. (canceled)
